(19) United States
(12) Patent Application Publication
(10) Pub. No.: US 2015/0036319 A1
(43) Pub. Date: Feb. 5, 2015

(54) DUAL PANEL DISPLAY

(71) Applicant: SHENZHEN CHINA STAR OPTOELECTRONICS TECHNOLOGIES CO., LTD., Shenzhen, Guangdong (CN)

(72) Inventor: Chao Ning, Shenzhen (CN)

(73) Assignee: Shenzhen China Star Optoelectronics Technology Co. Ltd., Shenzhen, Guangdong (CN)

(21) Appl. No.: 14/006,679

(22) PCT Filed: Aug. 1, 2013
(86) PCT No.: PCT/CN2013/080603

§ 371 Date: Sep. 22, 2013

(30) Foreign Application Priority Data
Jul. 30, 2013 (CN) 201310325439.7

(51) Int. Cl. G02F 1/1335

(52) U.S. Cl. CPC G02F 1/133606
USPC 362/97.1

(57) ABSTRACT

A dual panel display including a backlight module is disclosed. The backlight module includes a light source arranged between a first display panel and a second display panel, and a first diffusion plate and a second diffusion plate between the light source and the first display panel and the second display panel. The light source includes a PCB and LEDs arranged on the PCB. The PCB includes a first side facing toward the first diffusion plate and a second side facing toward the second diffusion plate. The first side and the second side include a plurality of LEDs arranged thereon. The first side and the second side include supporting members for supporting the first and the second diffusion plates such that the distance between the light source and the first and second diffusion plate is sustained.

### BACKGROUND OF THE INVENTION

1. Field of the Invention

The present disclosure relates to liquid crystal display technology, and more particularly to an enhanced structure of dual panel display.

2. Discussion of the Related Art

Nowadays, liquid crystal modules include direct-lit or edge-lit backlights. Both of the backlights can only emit lights from one surface, and can only cooperatively operate with one liquid crystal glass to display one image.

With the development, dual panel displays are needed for a plurality of places, such as government organizations, hospitals or supermarkets. In addition, in some of the places, such as Internet bars or general offices, two people sit face to face with one display device in front of them. Under the circumstance, the two display devices can be incorporated into one dual panel display with only one backlight module. The two display panels can be independently controlled so as to display the same or different images. As such, the cost, the power consumption and the space are effectively reduced, and also

Generally, one light source is shared by the two display panels, and a plurality of components are configured in a direction from the light source to the external side of the display panel in turn. In this way, the light source and the components are closely relative to the fixing structure of the outer frame. The internal structure of the dual panel display may be easily deformed when the fixing structure of the outer frame is not stable or when the fixing structure is affected by external forces. Thus, the quality and the performance of the dual panel display may be affected.

### SUMMARY

In one aspect, a dual panel display includes: a first display panel, a second display panel parallel to the first display panel, and a backlight module arranged between the first display panel and the second display panel, the backlight module includes a light source arranged between the first display panel and the second display panel, a first diffusion plate between the light source and the first display panel, a second diffusion plate between the light source and the second display panel, and a first optical film and a second optical film respectively arranged between the first diffusion plate and the first display panel and between the second diffusion plate and the second display panel, and the light source, the first diffusion plate and the second diffusion plate are parallel to the light source; wherein the light source includes a printed circuit board (PCB) and a plurality of LEDs on the PCB, the PCB includes a first side facing toward the first diffusion plate and a second side facing toward the second diffusion plate, and the first side and the second side respectively includes a plurality of LEDs arranged thereon; and the first side and the second side includes a plurality of supporting members for supporting the first diffusion plate or the second diffusion plate such that the distance between the light source and the first diffusion plate or the second diffusion plate is sustained.

Wherein the supporting member includes a base and a main body vertically protruding from the base.

Wherein the supporting member connects to the PCB via a bolt or the supporting member adheres to the PCB via the base.

Wherein the main body of the supporting member is cone-shaped.

Wherein the LEDs on the first side and the second side are arranged back to back with each other.

Wherein the LEDs on the first side and the second side are arranged back to back with each other.

Wherein the supporting members on the first side and the second side are arranged back to back with each other.

Wherein the supporting members on the first side and the second side are arranged back to back with each other.

Wherein the LEDs on the first side or the second side and the supporting members on the first side or the second side are arranged back to back each with other.

Wherein the LEDs on the first side or the second side and the supporting members on the first side or the second side are arranged back to back each with other.

Wherein second optical lens are arranged between the light source and the first diffusion plate and between the light source and the second diffusion plate for diffusing the light path of the light source.

Wherein second optical lens are arranged between the light source and the first diffusion plate and between the light source and the second diffusion plate for diffusing the light path of the light source.

Wherein the PCB includes a first circuit board facing toward the first diffusion plate and a second circuit board facing toward the second diffusion plate to independently control the LEDs on the first circuit board and the second circuit board.

Wherein the PCB includes a first circuit board facing toward the first diffusion plate and a second circuit board facing toward the second diffusion plate to independently control the LEDs on the first circuit board and the second circuit board.

Wherein the supporting members are made by transparent or white plastic materials.

Wherein the supporting members are made by transparent or white plastic materials.

In view of the above, the supporting members are configured between the light source and the two diffusion plates to support the diffusion plates. The distance between the light source and the two diffusion plate are sustained to prevent the dual panel display from being deformed due to the transportation or external forces. Thus, the light path of the light source and the display performance remain the same. In addition, the PCB can also be two circuit boards such that the LEDs arranged on the two circuit boards can be independently controlled. In this way, any one of the dual panels can be in sleep mode and thus to converse the power consumption.

### BRIEF DESCRIPTION OF THE DRAWINGS

FIG. 1 is a schematic view of a dual panel display in accordance with a first embodiment.

FIG. 2 is a schematic view showing the structure of the backlight module of the dual panel display of the first embodiment.

FIG. 3 is an enlarged view of the portion “A” in FIG. 2.

FIG. 4 is a partial view of the dual panel display in accordance with a second embodiment.

FIG. 5 is a schematic view showing the structure of the dual panel display in accordance with a third embodiment.

### DETAILED DESCRIPTION OF THE EMBODIMENTS

Embodiments of the invention will now be described more fully hereinafter with reference to the accompanying drawings, in which embodiments of the invention are shown.

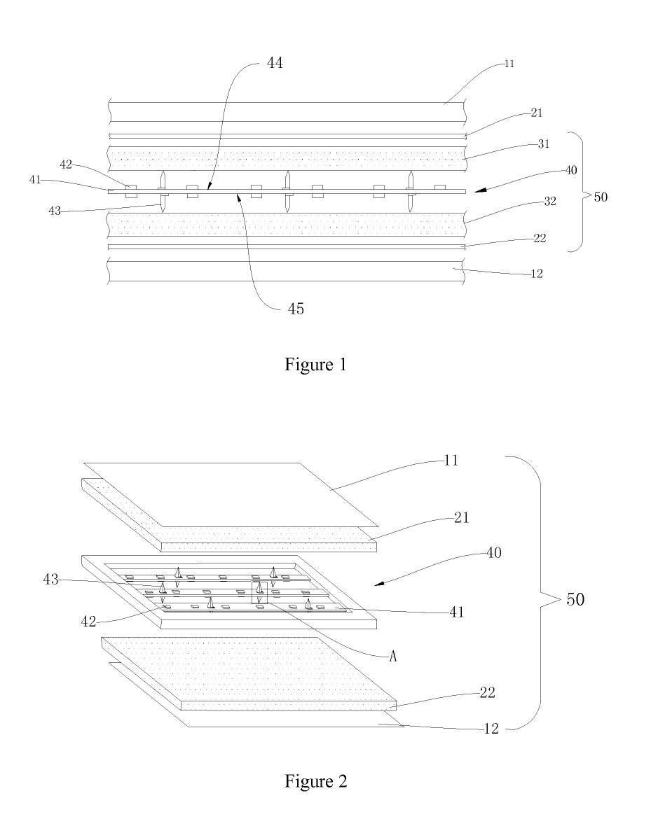

FIG. 1 is a schematic view of a dual panel display in accordance with a first embodiment. The dual panel display includes a first display panel 11, a second display panel 12 parallel to the first display panel 11, and a backlight module 50 arranged between the first display panel 11 and the second display panel 12. The backlight module 50 includes a light source 40 arranged between the first display panel 11 and the second display panel 12, a first diffusion plate 31 between the light source and the first display panel 11, a second diffusion plate 32 between the light source and the second display panel 12. The light source, the first diffusion plate 31 and the second diffusion plate 32 are parallel to the light source 40. In addition, a first optical film 21 and a second optical film 22 are respectively arranged between the first diffusion plate 31 and the first display panel 11 and between the second diffusion plate 32 and the second display panel 12.

The light source 40 includes a printed circuit board (PCB) 41 and LEDs 42 arranged at two sides of the PCB 41. The PCB 41 includes a first side 44 facing toward the first diffusion plate 31, and a second side 45 facing toward the second diffusion plate 32. The first side 44 and the second side 45 respectively includes a plurality of LEDs 42 arranged thereon. To facilitate the configuration of the lines on the PCB 41, the LEDs 42 on the first side 44 and the LEDs 42 on the second side 45 are arranged back to back with each other.

The first side 44 and the second side 45 includes a plurality of supporting members 43 for supporting the first diffusion plate 31 or the second diffusion plate 32 such that the distance between the light source 40 and the first diffusion plate 31 or the second diffusion plate 32 are sustained. In the embodiment, the LEDs 42 on the first side 44 and the LEDs 42 on the second side 45 are arranged back to back with each other. Also, the supporting members 43 on the first side 44 and the first side 44 of the PCB 41 are also arranged back to back with each other. The structure of the backlight module 50 is shown in FIG. 2.

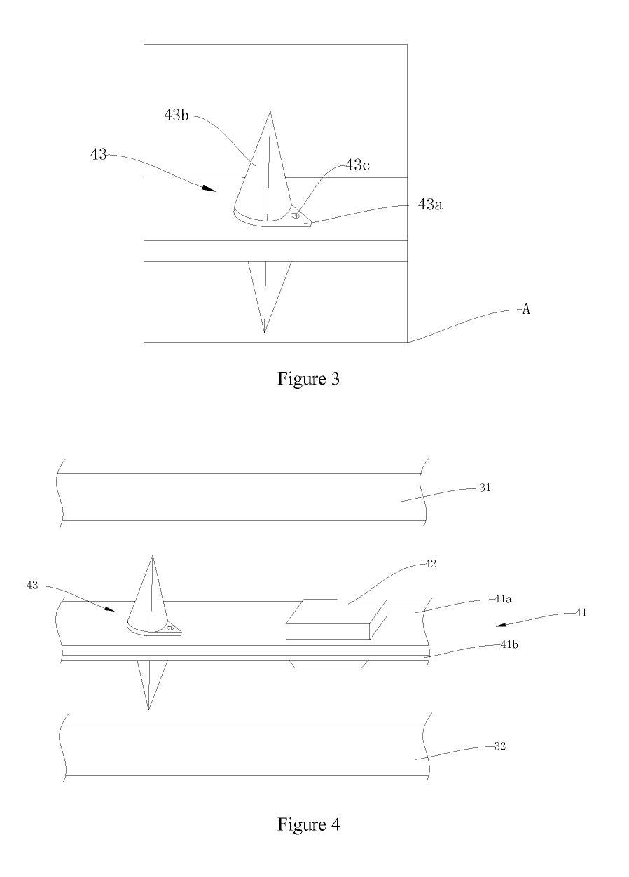

Referring to the enlarged view of FIG. 3, each of the supporting members 43 includes a base 43a and a main body 43b vertically protruding from the base 43a. The main body 43b are cone-shaped. The base 43a and the PCB 41 include corresponding screw holes (not shown) such that a bolt 43c passes through the screw holes (not shown) of the base 43a and the PCB 41 in turn. As such, the base 43a connects to the bolt and nut of the PCB 41 so as to fix the supporting members 43 on the PCB 41. Similarly, other supporting members 43 can be fixed in the same way. In other embodiments, the supporting members are adhered to the PCB.

In addition, in order to prevent the supporting members 43 from absorbing the lights emitted from the LEDs 42, which may affect the transmission rate, the supporting members 43 are made by transparent or white plastic materials, such as PE, PMMA, PS, ABS, PC, and so on.

It is to be noted that the lights emitted from the LEDs 42 may be easily blocked while a lot of supporting members 43 are configured. Thus, the number of the supporting members 43 has to be less than the number of LEDs. In one embodiment, one supporting member 43 is configured for every two, three or four LEDs 42 on one side of the PCB 41, such as the first side 44, so as to stably support the diffusion plate, such as the first diffusion plate 31. Thus, the distance between the diffusion plate and the source remains the same.

Corresponding, a height of the supporting member 43 is configured according to the respective distance between the first diffusion plate 31 and the light source 40 and between the second diffusion plate 32 and the light source. Generally, the distance between the first diffusion plate 31 and the light source 40 is equal to that between the second diffusion plate 32 and the light source 40. Thus, the shape and dimension of the supporting members 43 arranged on two sides of the PCB 41 are substantially the same.

Furthermore, as the distance between the light source and the two diffusion plates (light mixing distance) is shorten, the structure disclosed in the above embodiment is also applicable to light and thin dual panel displays. In one aspect, the height of the supporting members 43 is reduced so as to be compatible with the distance between the light source 40 and the first and second diffusion plate 31, 32. However, in order to diffuse the lights emitted from the LEDs 42 in a shorter distance, second optical lens (not shown) are arranged on the surface of the LEDs 42 for diffusing the light paths.

In the second embodiment, the two display panels of the dual panel display can be independently controlled. The PCB 41 is assembled by two circuit boards. As shown in FIG. 4, the PCB 41 includes a first circuit board 41a facing toward the first diffusion plate 31 and a second circuit board 41b facing toward the second diffusion plate 32. The first circuit board 41a and the second circuit board 41b are arranged back to back with each other. Each of the first circuit board 41a and the second circuit board 41b includes circuits independent from each other such that the LEDs 42 on the first circuit board 41a and the second circuit board 41b are controlled independently. Correspondingly, the supporting members 43 are respectively fixed on the first circuit board 41a and the second circuit board 41b. As such, any one of the display panels of the dual panel display can be in its operation or in a sleep mode without affecting each other. Also, the power consumption of the display panel in the sleep mode is reduced. Other structures of the dual panel display are similar to that in the first embodiment.

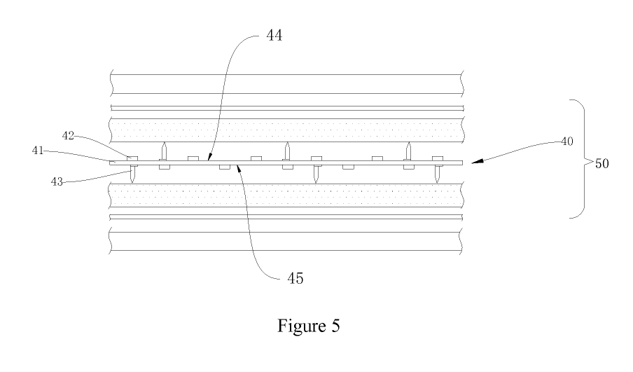

As shown in FIG. 5, In the third embodiment, the configuration of the LEDs 42 and the supporting members 43 of the backlight module 50 is different from that in the first embodiment. In the embodiment, the light source 40 includes the LEDs 42 and the PCB 41 that are connected with each other. The LEDs 42 on the first side 44 and the supporting members 43 on the second side 45 are arranged back to back with each other, or the LEDs 42 on the second side 45 and the supporting members 43 on the first side 44 area arranged back to back with each other. With such configuration, the lights emitted from the LEDs 42 on either the first side 44 or the second side 45 are uniformly distributed. Other structures of the dual panel display are similar to that in the first embodiment.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A dual panel display, comprising:
a first display panel, a second display panel parallel to the first display panel, and a backlight module arranged between the first display panel and the second display panel, the backlight module comprises a light source arranged between the first display panel and the second display panel, a first diffusion plate between the light source and the first display panel, a second diffusion plate between the light source and the second display panel, and a first optical film and a second optical film respectively arranged between the first diffusion plate and the first display panel and between the second diffusion plate and the second display panel, and the light source, the first diffusion plate and the second diffusion plate are parallel to the light source;
wherein the light source comprises a printed circuit board (PCB) and a plurality of LEDs on the PCB, the PCB comprises a first side facing toward the first diffusion plate and a second side facing toward the second diffusion plate, and the first side and the second side respectively comprises a plurality of LEDs arranged thereon; and
the first side and the second side comprises a plurality of supporting members for supporting the first diffusion plate or the second diffusion plate such that the distance between the light source and the first diffusion plate or the second diffusion plate is sustained.

2. The dual panel display as claimed in claim 1, wherein the supporting member comprises a base and a main body vertically protruding from the base.

3. The dual panel display as claimed in claim 2, wherein the supporting member connects to the PCB via a bolt or the supporting member adheres to the PCB via the base.

4. The dual panel display as claimed in claim 2, wherein the main body of the supporting member is cone-shaped.

5. The dual panel display as claimed in claim 1, wherein the LEDs on the first side and the second side are arranged back to back with each other.

6. The dual panel display as claimed in claim 2, wherein the LEDs on the first side and the second side are arranged back to back with each other.

7. The dual panel display as claimed in claim 1, wherein the supporting members on the first side and the second side are arranged back to back with each other.

8. The dual panel display as claimed in claim 2, wherein the supporting members on the first side and the second side are arranged back to back with each other.

9. The dual panel display as claimed in claim 1, wherein the LEDs on the first side or the second side and the supporting members on the first side or the second side are arranged back to back each with other.

10. The dual panel display as claimed in claim 2, wherein the LEDs on the first side or the second side and the supporting members on the first side or the second side are arranged back to back each with other.

11. The dual panel display as claimed in claim 1, wherein second optical lens are arranged between the light source and the first diffusion plate and between the light source and the second diffusion plate for diffusing the light path of the light source.

12. The dual panel display as claimed in claim 2, wherein second optical lens are arranged between the light source and the first diffusion plate and between the light source and the second diffusion plate for diffusing the light path of the light source.

13. The dual panel display as claimed in claim 1, wherein the PCB comprises a first circuit board facing toward the first diffusion plate and a second circuit board facing toward the second diffusion plate to independently control the LEDs on the first circuit board and the second circuit board.

14. The dual panel display as claimed in claim 2, wherein the PCB comprises a first circuit board facing toward the first diffusion plate and a second circuit board facing toward the second diffusion plate to independently control the LEDs on the first circuit board and the second circuit board.

15. The dual panel display as claimed in claim 1, wherein the supporting members are made by transparent or white plastic materials.

16. The dual panel display as claimed in claim 2, wherein the supporting members are made by transparent or white plastic materials.
